(19) United States
(12) Patent Application Publication
(10) Pub. No.: US 2015/0060022 A1
(43) Pub. Date: Mar. 5, 2015

(54) VAPOR CHAMBER AND METHOD OF MANUFACTURING THE SAME

(71) Applicant: Cooler Master (Hui Zhou) Co., Ltd., Huizhou (CN)

(72) Inventors: Chien-Hung Sun, Huizhou (CN); Te-Hsuan Chin, Huizhou (CN)

(73) Assignee: Cooler Master (Hui Zhou) Co., Ltd., Huizhou (CN)

(21) Appl. No.: 14/047,010

(22) Filed: Oct. 6, 2013

(30) Foreign Application Priority Data
Aug. 29, 2013 (CN) 201310384951.9

(51) Int. Cl. F28D 15/02; B23P 15/26

(52) U.S. Cl. CPC F28D 15/02; B23P 15/26
USPC 165/104.26; 29/890.032; 165/104.21

(57) ABSTRACT

A vapor chamber includes a first metal cover plate and a second metal cover plate. The first metal cover plate has a plurality of first support portions, each of the first support portions has a head portion and a neck portion, and the head portion is extended from the neck portion. The second metal cover plate has a plurality of second support portions, each of the second support portions has a through hole and an engaging recess, and the engaging recess is formed in the through hole. The head portion is disposed in the engaging recess and the neck portion is disposed in the through hole, such that the first support portion and the second support portion are engaged with each other.

### BACKGROUND OF THE INVENTION

1. Field of the Invention

The invention relates to a vapor chamber and a method of manufacturing the same and, more particularly, to a method for forming a support structure by engagement between two metal cover plates of a vapor chamber.

2. Description of the Prior Art

In a vapor chamber, a working fluid is filled in a sealed chamber. The working fluid can be evaporated and condensed in cycles such that heat can be conducted by the vapor chamber uniformly and rapidly. In general, the vapor chamber essentially consists of metal casing, capillary structure and working fluid and is manufactured by an annealing process, a vacuumizing process, a soldering and sealing process, and so on. Furthermore, to prevent the vapor chamber from caving in or bulging out, the prior art disposes a plurality of support members in the metal casing and solders opposite ends of each support member onto upper and lower metal cover plates of the metal casing. Since the cost of soldering process is higher than other processes, the manufacture cost of the vapor chamber will increase accordingly.

### SUMMARY OF THE INVENTION

The invention provides a vapor chamber and a method for forming a support structure by engagement between two metal cover plates of a vapor chamber, so as to solve the aforesaid problems.

According to an embodiment of the invention, a vapor chamber comprises a first metal cover plate and a second metal cover plate. The first metal cover plate has a plurality of first support portions, each of the first support portions has a head portion and a neck portion, the head portion is extended from the neck portion, and a width of the head portion is larger than a width of the neck portion. The second metal cover plate has a plurality of second support portions, each of the second support portions has a through hole and an engaging groove formed therein, the engaging groove is located within the through hole, a width of the engaging groove is larger than the width of the head portion, a width of the through hole is smaller than the width of the head portion, the width of the through hole is larger than the width of the neck portion, the head portion is disposed in the engaging portion, and the neck portion is disposed in the through hole, such that the first support portion and the second support portion are engaged with each other.

According to another embodiment of the invention, a method of manufacturing a vapor chamber comprises steps of providing a first metal cover plate and a second metal cover plate, wherein the first metal cover plate has a plurality of first support portions, each of the first support portions has a head portion and a neck portion, the head portion is extended from the neck portion, a width of the head portion is larger than a width of the neck portion, the second metal cover plate has a plurality of second support portions, each of the second support portions has a through hole and an engaging groove formed therein, the engaging groove is located within the through hole, a width of the engaging groove is larger than the width of the head portion, a width of the through hole is smaller than the width of the head portion, and the width of the through hole is larger than the width of the neck portion; and assembling the first metal cover plate and the second metal cover plate with each other by disposing the head portion in the engaging groove and disposing the neck portion in the through hole, such that the first support portion and the second support portion are engaged with each other.

As mentioned in the above, the invention forms the first support portions and the second support portions on the first metal cover plate and the second metal cover plate, respectively, and engages the first support portions and the second support portions with each other, so as to forma support structure between the first metal cover plate and the second metal cover plate. Since the invention forms the support structure by engagement between two metal cover plates of the vapor chamber, the process of the invention is simple and the efficiency of manufacturing the vapor chamber can be improved effectively so that the manufacture cost can be reduced.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart illustrating a method of manufacturing a vapor chamber according to a first embodiment of the invention.

FIG. 2 is a cross-sectional view illustrating a vapor chamber before a punching process.

FIG. 3 is a cross-sectional view illustrating the vapor chamber after the punching process.

FIG. 4 is a perspective view illustrating circular first support portion and circular second support portion.

FIG. 5 is a perspective view illustrating rectangular first support portion and rectangular second support portion.

FIG. 6 is another perspective view illustrating rectangular first support portion and rectangular second support portion.

FIG. 7 is a cross-sectional view illustrating a vapor chamber before a punching process according to a second embodiment of the invention.

### DETAILED DESCRIPTION

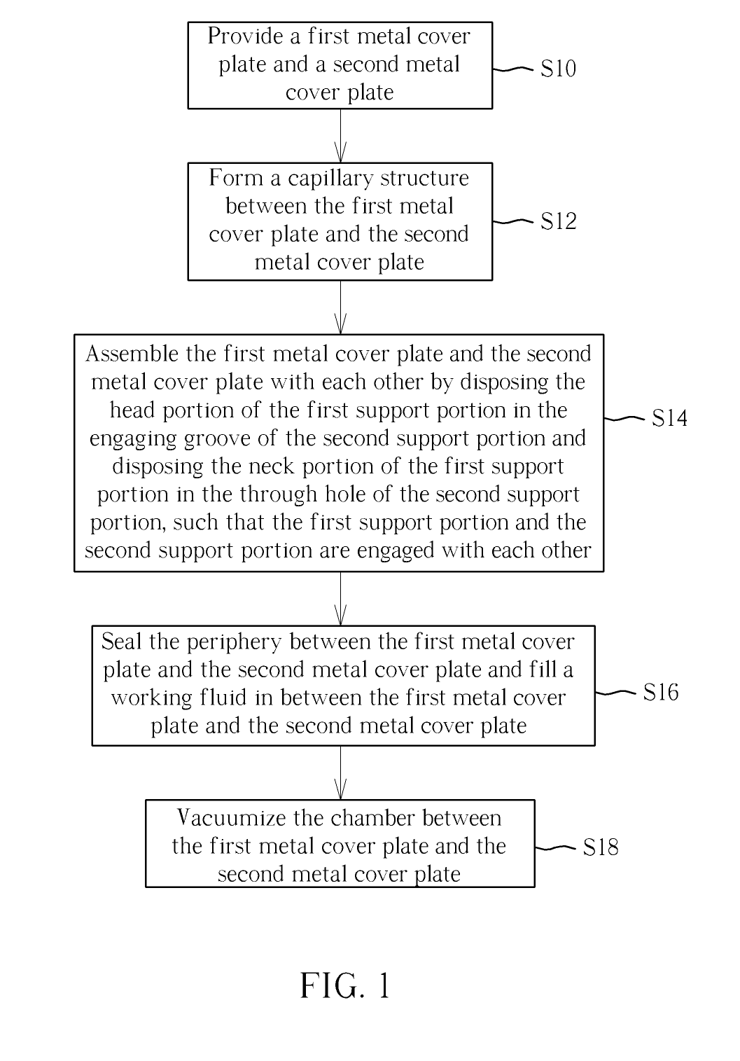

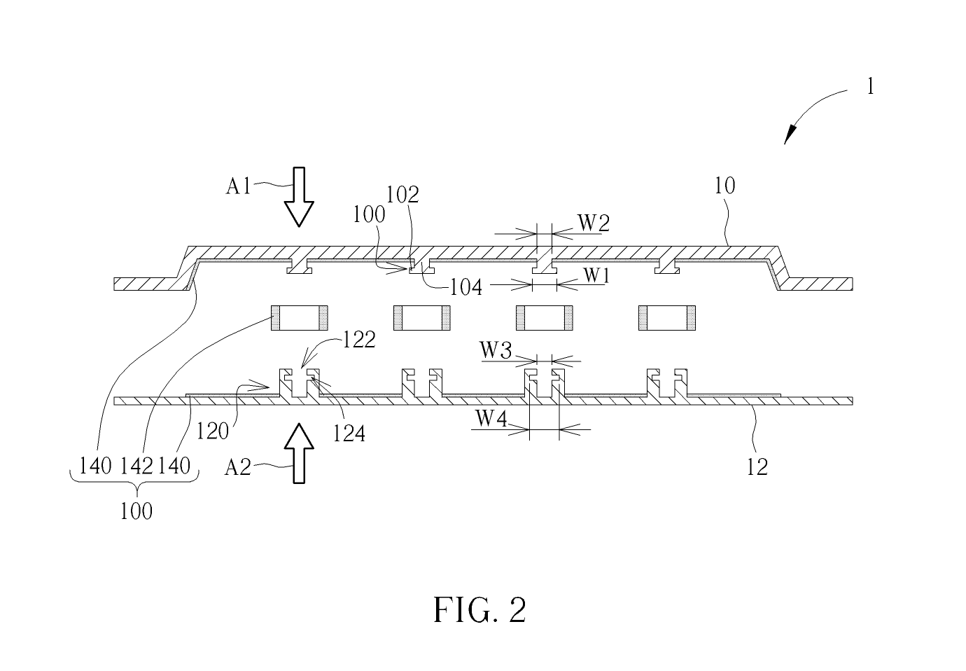

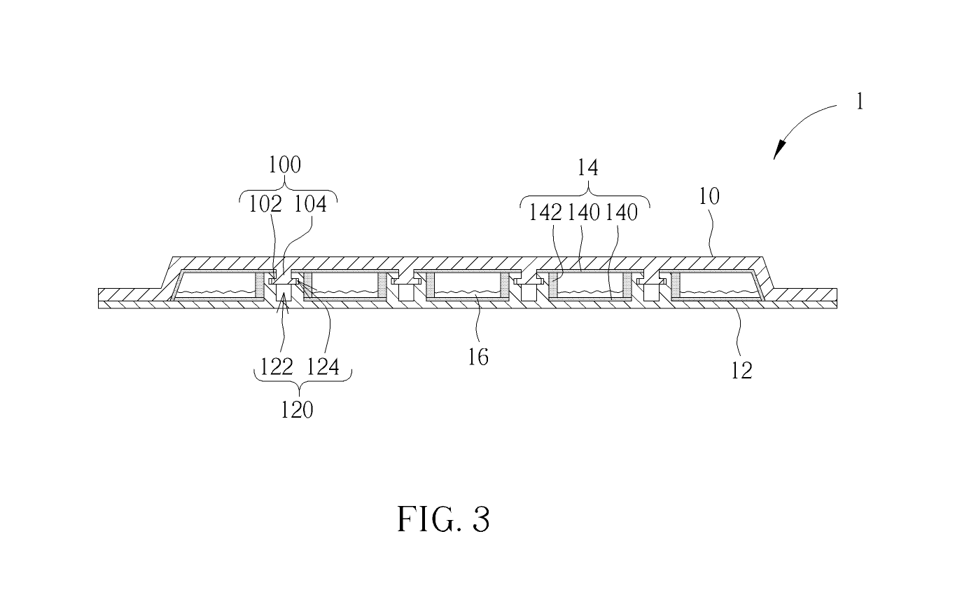

Referring to FIGS. 1 to 3, FIG. 1 is a flowchart illustrating a method of manufacturing a vapor chamber according to a first embodiment of the invention, FIG. 2 is a cross-sectional view illustrating a vapor chamber 1 before a punching process, and FIG. 3 is a cross-sectional view illustrating the vapor chamber 1 after the punching process.

First of all, step S10 is performed to provide a first metal cover plate 10 and a second metal cover plate 12. As shown in FIG. 2, the first metal cover plate 10 has a plurality of first support portions 100 and the second metal cover plate 12 has a plurality of second support portions 120. In this embodiment, the first metal cover plate 10 and the second metal cover plate 12 may be made of, but not limited to, copper, aluminum or other metal with low hardness by an extrusion process, such that the first support portions 100 and the first metal cover plate 10 are formed integrally, and the second support portions 120 and the second metal cover plate 12 are formed integrally. Each of the first support portions 100 has a head portion 102 and a neck portion 104, and the head portion 102 is extended from the neck portion 104, wherein a width W1 of the head portion 102 is larger than a width W2 of the neck portion 104. Furthermore, each of the second support portions 120 has a through hole 122 and an engaging groove 124 formed therein, and the engaging groove 124 is located within the through hole 122, wherein a width W4 of the engaging groove 124 is larger than the width W1 of the head portion 102, a width W3 of the through hole 122 is smaller than the width W1 of the head portion 102, and the width W3 of the through hole 122 is larger than the width W2 of the neck portion 104.

Afterward, step S12 is performed to form a capillary structure 14 between the first metal cover plate 10 and the second metal cover plate 12, wherein the capillary structure 14 may be a groove-type capillary structure, a porous capillary structure, a mesh capillary structure, a sintered capillary structure or a compound capillary structure according to practical applications. It should be noted that the aforesaid compound capillary structure may consist of at least two capillary structures selected from the groove-type capillary structure, the porous capillary structure, the mesh capillary structure and the sintered capillary structure. Moreover, the capillary structure 14 may comprise a sheet-shaped capillary structure 140 and a pillar-shaped capillary structure 142. In this embodiment, the sheet-shaped capillary structure 140 may be formed on inner side walls of the first metal cover plate 10 and the second metal cover plate 12, and the pillar-shaped capillary structure 142 may be sleeved on the second support portions 120 of the second metal cover plate 12.

Step S14 is then performed to assemble the first metal cover plate 10 and the second metal cover plate 12 with each other by disposing the head portion 102 of the first support portion 100 in the engaging groove 124 of the second support portion 120 and disposing the neck portion 104 of the first support portion 100 in the through hole 122 of the second support portion 120, such that the first support portion 100 and the second support portion 120 are engaged with each other. While assembling the first metal cover plate 10 and the second metal cover plate 12 with each other, the method of the invention may make the head portion 102 of the first support portion 100 abut against the through hole 122 of the second support portion 120. Then, the method of the invention may punch the first metal cover plate 10 and the second metal cover plate 12 in directions indicated by the arrows A1 and A2 of FIG. 2 so as to enable the head portion 102 of the first support portion 100 to pass through the through hole 122 of the second support portion 120 and then to be engaged in the engaging groove 124 of the second support portion 120.

Step S16 is then performed to seal the periphery between the first metal cover plate 10 and the second metal cover plate 12 and fill a working fluid 16 (e.g. water) in between the first metal cover plate 10 and the second metal cover plate 12. Finally, step S18 is performed to vacuumize the chamber between the first metal cover plate 10 and the second metal cover plate 12 so as to complete the vapor chamber 1 shown in FIG. 3. As shown in FIG. 3, the vapor chamber 1, which is manufactured by the aforesaid steps, comprises the aforesaid first metal cover plate 10, second metal cover plate 12, capillary structure 14 and working fluid 16. Since the invention forms the support structure by engagement between the first metal cover plate 10 and the second metal cover plate 12, the process of the invention is simple and the efficiency of manufacturing the vapor chamber 1 can be improved effectively so that the manufacture cost can be reduced.

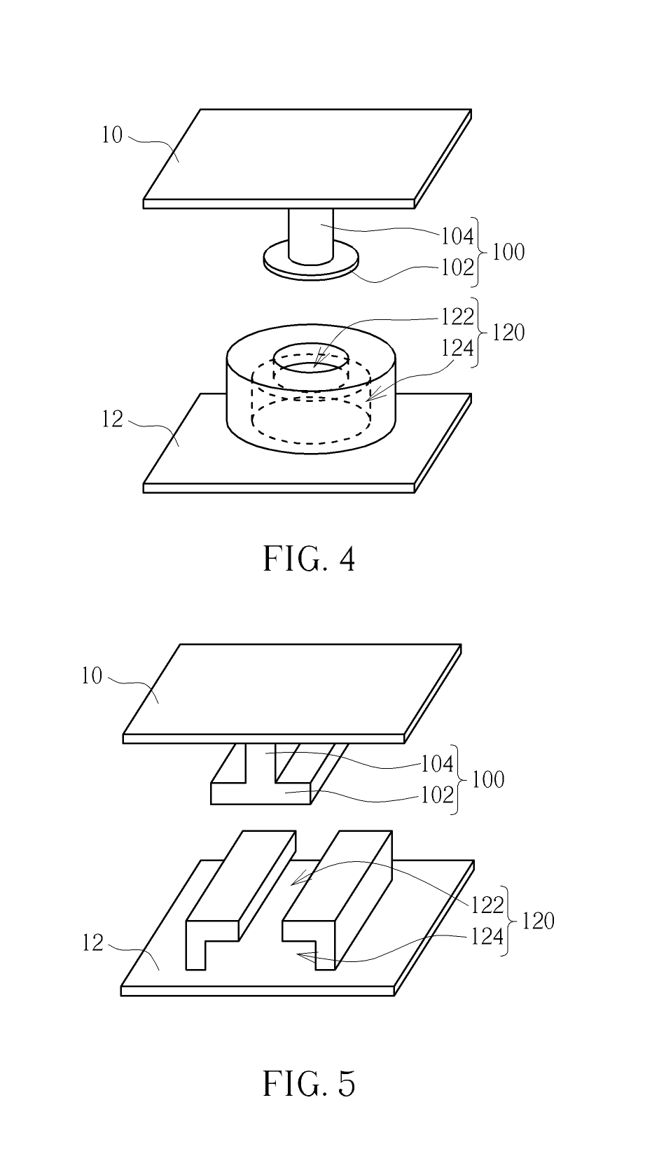

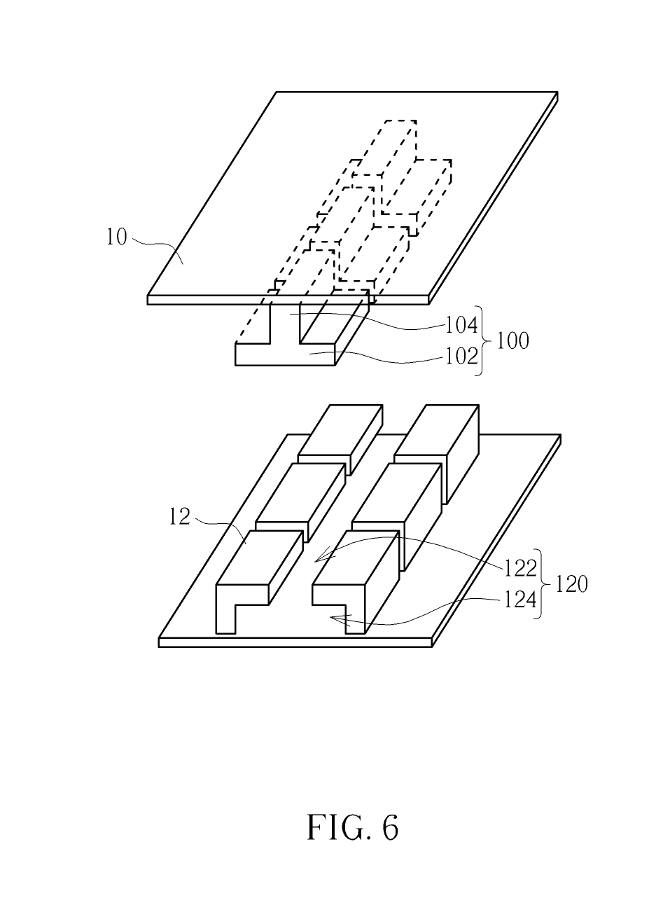

Referring to FIGS. 4 to 6, FIG. 4 is a perspective view illustrating circular first support portion 100 and circular second support portion 120, FIG. 5 is a perspective view illustrating rectangular first support portion 100 and rectangular second support portion 120, and FIG. 6 is another perspective view illustrating rectangular first support portion 100 and rectangular second support portion 120. As shown in FIG. 4, the first support portion 100 and the second support portion may be circular. As shown in FIG. 5, the first support portion 100 and the second support portion may be rectangular, wherein the first support portion 100 and the second support portion 120 may be formed as a bar by an extrusion process. As shown in FIG. 6, the invention may mill the first support portion 100 and the second support portion 120 shown in FIG. 5 into a plurality of short first support portions 100 and a plurality of short second support portions 120 according to practical applications.

When the first support portion 100 and the second support portion 120 are rectangular as shown in FIGS. 5 and 6, in addition to the aforesaid punching process, the invention may also slide the first metal cover plate 10 and the second metal cover plate 12 with respect to each other so as to embed the neck portion 104 and the head portion 102 of the first support portion 100 into the through hole 122 and the engaging groove 124 of the second support portion 120, respectively, such that the first support portion 100 and the second support portion 120 are engaged with each other.

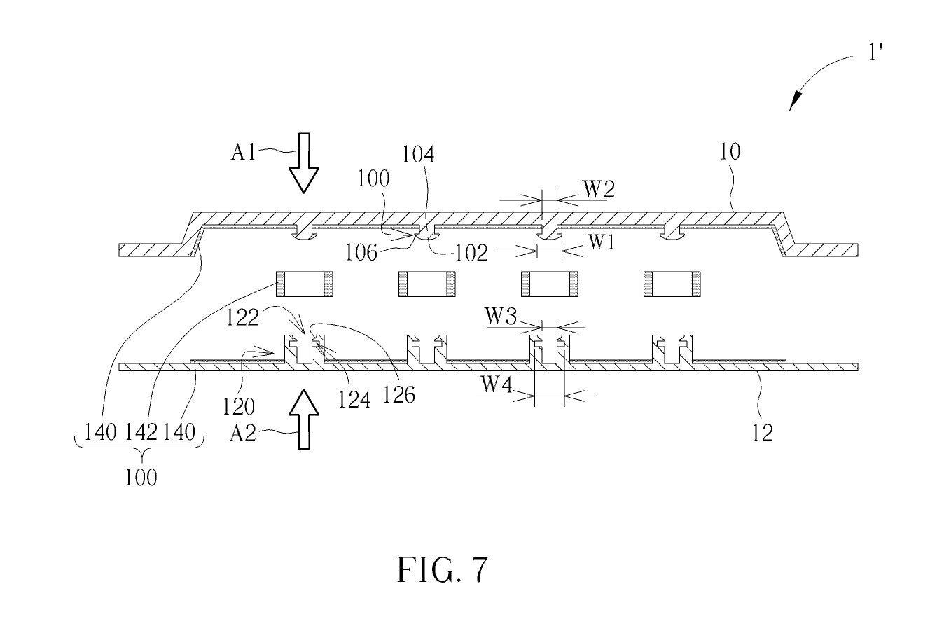

Referring to FIG. 7 along with FIG. 2, FIG. 7 is a cross-sectional view illustrating a vapor chamber 1′ before a punching process according to a second embodiment of the invention. The difference between the vapor chamber 1′ and the aforesaid vapor chamber 1 is that the head portion 102 of the first support portion 100 of the vapor chamber 1′ has a first inclined edge 106, and the through hole 122 of the second support portion 120 of the vapor chamber 1′ has a second inclined edge 126, wherein an inclined direction of the first inclined edge 106 is identical to an inclined direction of the second inclined edge 126. Accordingly, during the punching process, the first inclined edge 106 will push the second inclined edge 126 forward so as to enable the second support portion 120 to deform elastically. Consequently, the head portion 102 of the first support portion 100 can pass through the through hole 122 of the second support portion 120 and then be engaged in the engaging groove 124 of the second support portion 120. Therefore, the punching process may be much smoother and the assembly yield rate may be enhanced due to the cooperation between the first inclined edge 106 and the second inclined edge 126. In this embodiment, the first inclined edge 106 and the second inclined edge 126 are arc-shaped. However, in another embodiment, the first inclined edge 106 and the second inclined edge 126 may also be flat. It should be noted that the same elements in FIG. 7 and FIG. 2 are represented by the same numerals, so the repeated explanation will not be depicted herein again.

As mentioned in the above, the invention forms the first support portions and the second support portions on the first metal cover plate and the second metal cover plate, respectively, and engages the first support portions and the second support portions with each other, so as to form a support structure between the first metal cover plate and the second metal cover plate. Since the invention forms the support structure by engagement between two metal cover plates of the vapor chamber, the process of the invention is simple and the efficiency of manufacturing the vapor chamber can be improved effectively so that the manufacture cost can be reduced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A vapor chamber comprising:
a first metal cover plate having a plurality of first support portions, each of the first support portions having a head portion and a neck portion, the head portion being extended from the neck portion, a width of the head portion being larger than a width of the neck portion; and
a second metal cover plate having a plurality of second support portions, each of the second support portions having a through hole and an engaging groove formed therein, the engaging groove being located within the through hole, a width of the engaging groove being larger than the width of the head portion, a width of the through hole being smaller than the width of the head portion, the width of the through hole being larger than the width of the neck portion, the head portion being disposed in the engaging portion, and the neck portion being disposed in the through hole, such that the first support portion and the second support portion are engaged with each other.

2. The vapor chamber of claim 1, wherein the head portion has a first inclined edge, the through hole has a second inclined edge, and an inclined direction of the first inclined edge is identical to an inclined direction of the second inclined edge.

3. The vapor chamber of claim 1, wherein the first support portion is circular or rectangular and the second support portion is circular or rectangular corresponding to the first support portion.

4. The vapor chamber of claim 1, wherein the first metal cover plate and the second metal cover plate are made of copper or aluminum.

5. The vapor chamber of claim 1, further comprising:
a capillary structure disposed between the first metal cover plate and the second metal cover plate; and
a working fluid filled in between the first metal cover plate and the second metal cover plate.

6. The vapor chamber of claim 5, wherein the capillary structure is a groove-type capillary structure, a porous capillary structure, a mesh capillary structure, a sintered capillary structure or a compound capillary structure.

7. A method of manufacturing a vapor chamber comprising steps of:
providing a first metal cover plate and a second metal cover plate, wherein the first metal cover plate has a plurality of first support portions, each of the first support portions has a head portion and a neck portion, the head portion is extended from the neck portion, a width of the head portion is larger than a width of the neck portion, the second metal cover plate has a plurality of second support portions, each of the second support portions has a through hole and an engaging groove formed therein, the engaging groove is located within the through hole, a width of the engaging groove is larger than the width of the head portion, a width of the through hole is smaller than the width of the head portion, and the width of the through hole is larger than the width of the neck portion; and
assembling the first metal cover plate and the second metal cover plate with each other by disposing the head portion in the engaging groove and disposing the neck portion in the through hole, such that the first support portion and the second support portion are engaged with each other.

8. The method of claim 7, wherein the step of assembling the first metal cover plate and the second metal cover plate with each other comprises steps of:
making the head portion abut against the through hole; and
punching the first metal cover plate and the second metal cover plate so as to enable the head portion to pass through the through hole and then to be engaged in the engaging groove.

9. The method of claim 8, wherein the head portion has a first inclined edge, the through hole has a second inclined edge, and an inclined direction of the first inclined edge is identical to an inclined direction of the second inclined edge; during the punching step, the first inclined edge pushes the second inclined edge forward so as to enable the head portion to pass through the through hole and then to be engaged in the engaging groove.

10. The method of claim 7, wherein the step of assembling the first metal cover plate and the second metal cover plate with each other comprises step of:
sliding the first metal cover plate and the second metal cover plate with respect to each other so as to embed the neck portion and the head portion into the through hole and the engaging groove, respectively.

11. The method of claim 7, wherein the first support portion is circular or rectangular and the second support portion is circular or rectangular corresponding to the first support portion.

12. The method of claim 7, wherein the first metal cover plate and the second metal cover plate are made of copper or aluminum.

13. The method of claim 7, further comprising steps of:
forming a capillary structure between the first metal cover plate and the second metal cover plate; and
filling a working fluid in between the first metal cover plate and the second metal cover plate.

14. The method of claim 13, wherein the capillary structure is a groove-type capillary structure, a porous capillary structure, a mesh capillary structure, a sintered capillary structure or a compound capillary structure.
